(19) United States
(12) Patent Application Publication
(10) Pub. No.: US 2014/0149164 A1
(43) Pub. Date: May 29, 2014

(54) SCHEDULING MANAGEMENT SYSTEM AND SCHEDULING MANAGEMENT METHOD

(71) Applicant: Hitachi, Ltd., Tokyo (JP)

(72) Inventors: YOSHIKI YUMBE, Tokyo (JP); HIROYUKI HORI, Tokyo (JP)

(73) Assignee: Hitachi, Ltd., Tokyo (JP)

(21) Appl. No.: 14/087,607

(22) Filed: Nov. 22, 2013

(30) Foreign Application Priority Data
Nov. 27, 2012 (JP) 2012-258167

(51) Int. Cl. G06Q 10/06

(52) U.S. Cl. CPC G06Q 10/063114
USPC 705/7.15; 705/7.16

(57) ABSTRACT

A scheduling management system including a computer and a terminal device, and further containing a calculation unit to calculate the cost of work on the work target; a decision unit to decide if reorganization of the work schedule is needed or not; and a schedule generator unit to generate the work schedule; and in which the decision unit finds the progress of the work by comparing the work schedule with the work results, and decides if reorganization of the work schedule is needed based on the degree of divergence between the work schedule and the work progress; and the calculation unit calculates the work group cost generated by unifying the work groups for the combination of the work groups; and the schedule generator unit reorganizes the work schedule by comparing the calculated costs, and unifies the work groups based on results from the cost comparison.

### CLAIM OF PRIORITY

This application claims priority to Japanese Patent Application No. 2012-258167 filed on Nov. 27, 2012.

### BACKGROUND

The present invention relates to a system for managing a schedule for visiting a plurality of locations.

The background art of the present technical field is represented by Japanese Unexamined Patent Application Publication No. 2003-26335. The Japanese Unexamined Patent Application Publication No. 2003-26335 discloses a scheduling method for vehicle distribution that generates an optimal schedule for vehicle distribution in which all target points can be visited in the shortest possible time by a minimum number of vehicles.

### SUMMARY

The method disclosed in Japanese Unexamined Patent Application Publication No. 2003-26335 is capable of rendering a work schedule for efficiently visiting a large number of work targets scattered within a wide area. However, in the course of visits and work in conformance to the generated schedule, there are occasions where work not included in the schedule is necessary or the work cannot be performed as specified in the initial schedule due to work delays and so on. The method disclosed in Japanese Unexamined Patent Application Publication No. 2003-26335 is capable of generating an initial vehicle distribution schedule and work schedule but is not capable of dynamically re-optimizing the currently utilized scheduling to match the progress of the current work schedule. Therefore, if work outside the current schedule is required or the work cannot be performed according to the initial schedule then dynamic optimizing of the initial work schedule according to the progress status of the work schedule is required.

A typical example of the invention disclosed in these specifications is rendered as follows. Namely, a scheduling management system to generate a work schedule that includes a plurality of work targets includes a computer and a plurality of terminal devices coupled to the computer. The work targets are classified into work groups containing at least one work target. The computer includes a storage unit to retain position information for the work target, work schedule for the work target, and work results sent from the terminal device; a calculation unit to calculate the cost of work for the work target based on the position information, the work schedule, and the work results; a decision unit to decide if reorganization of the work schedule is needed or not based on the position information, the work schedule, and the work results; a schedule generator unit to generate a work schedule based on the decision results from the decision unit and the cost calculated by the calculation unit. The terminal device includes a display unit to display the work schedule sent from the computer, an operating unit for entering the work results, and a communication unit to send the work results to the computer. The decision unit find the progress status of the work by comparing the work schedule with the work results and decides if reorganizing of the work schedule is needed or not based on the degree of divergence between the work schedule and the progress status of the work; the calculation unit calculates the cost for a unified work group formed from different work groups, for each combination of work groups when the decision unit decided that reorganization of the work schedule is needed, and the schedule generator unit compares the calculated costs and by unifying the work groups based on results from the cost comparison, reorganizes the work schedule.

The representative example of the present invention is capable of optimizing the work schedule. The issues, configurations and effects other than described above are clarified in the following embodiments.

### BRIEF DESCRIPTION OF THE DRAWINGS

FIG. 1 is a block diagram showing one example of the entire structure of the schedule dynamic optimizing system of the first embodiment;

FIG. 2 is a block diagram showing one example of the structure of the portable information terminal of the first embodiment;

FIG. 3 is a block diagram showing one example of the structure of the server system of the first embodiment;

FIG. 4 is a drawing for describing one example of the database structure of the first embodiment;

FIG. 5 is a drawing for describing one example of the structure of the work schedule data of the first embodiment;

FIG. 6 is a table for describing one example of the structure of the facility information data of the first embodiment;

FIG. 7 is a table for describing one example of the structure of the resource data of the first embodiment;

FIG. 8 is a table for describing one example of the structure of the work result data of the first embodiment;

FIG. 9A is a drawing for describing a specific example of the re-optimizing processing of the first embodiment;

FIG. 9B is a drawing for describing a specific example of the re-optimizing processing of the first embodiment;

FIG. 10 is a flow chart of the schedule optimizing processing of the first embodiment;

FIG. 11 is an illustration for describing one example of the display shown on the display unit of the portable information terminal of the first embodiment;

FIG. 12 is an illustration for describing one example of the display shown on the display unit of the portable information terminal of the first embodiment;

FIG. 13 is a flow chart showing the rescheduling decision processing of the first embodiment;

FIG. 14 is a flow chart showing in detail the processing in step 1302 of the rescheduling decision processing of the first embodiment;

FIG. 15 is a drawing for describing a specific example of the rescheduling decision processing of the first embodiment;

FIG. 16 is a drawing for describing the work group of the first embodiment;

FIG. 17 is a graph for describing one example of the penalty function of the first embodiment;

FIG. 18 is a flow chart showing in detail the work schedule re-optimizing processing of the first embodiment;

FIG. 19A is a drawing showing a specific example of the initial work group cluster generating processing of the first embodiment;

FIG. 19B is a drawing showing a specific example of the initial work group cluster generating processing of the first embodiment;

FIG. 20 is a drawing for describing a specific example of the unified priority calculation processing of the first embodiment;

FIG. 21A is a drawing for describing a specific example of the unified priority calculation processing of the first embodiment;

FIG. 21B is a drawing for describing a specific example of the unified priority calculation processing of the first embodiment;

FIG. 22 is a drawing for describing a specific example of the unified priority calculation processing of the first embodiment;

FIG. 23 is a drawing for describing a specific example of the unified priority refresh processing of the first embodiment; and

FIG. 24 is a block diagram showing one example of the structure of the on-board car navigation device of the second embodiment.

### DETAILED DESCRIPTION

The embodiments of the present invention are described next while referring to the accompanying drawings.

### First Embodiment

The present embodiment describes one example of the schedule dynamic optimizing system 100 to dynamically re-optimize the schedule according to circumstances, and to output the optimized schedule when work other than in the work schedule such as visits, inspections, troubleshooting, and customer service of power distribution facilities such as power poles is required or when unable to perform work as described in the work schedule.

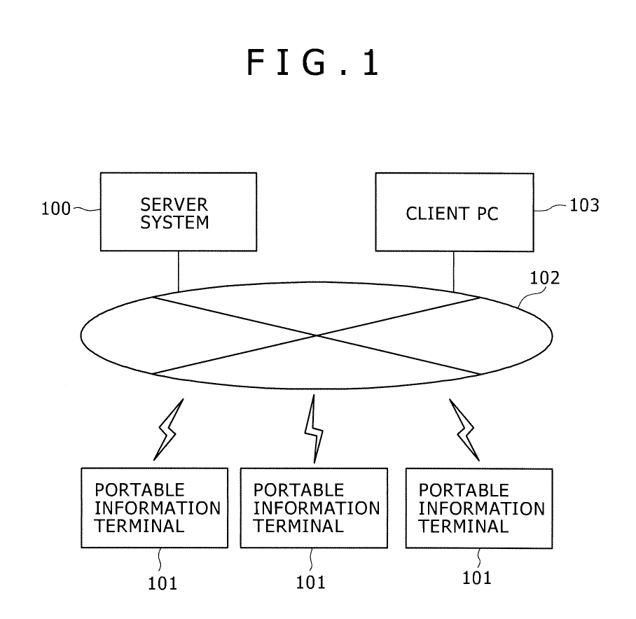

FIG. 1 is a block diagram showing one example of the entire structure of the schedule dynamic optimizing system of the first embodiment of the present invention.

The schedule dynamic optimizing system includes a server system 100, a client terminal 103, and a plurality of portable information terminals 101, and these components are coupled by way of a network 102. The drawing in FIG. 1 shows three portable information terminals but the number of coupled portable information terminals is not limited to this quantity and for example the number of portable information terminals may be equivalent to the number of workers performing the work, and the workers carrying the portable information terminals go to the work site and perform the work. The structural elements of this system are described hereafter.

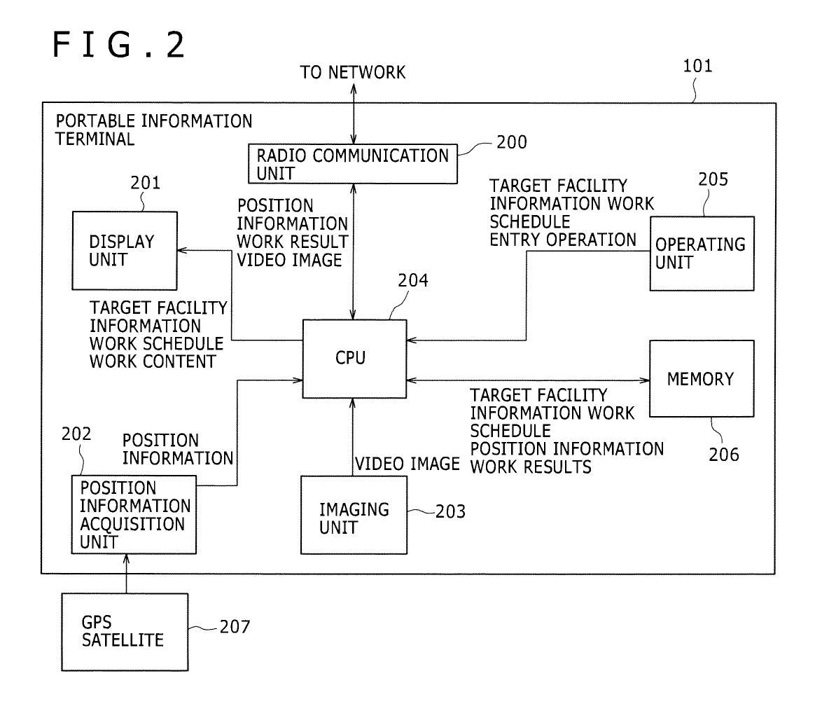

FIG. 2 is a block diagram showing one example of the structure of the portable information terminal 101 of the first embodiment.

The portable information terminal 101 includes a radio communication unit 200, a display unit 201, a position information acquisition unit 202, an imaging unit 203, a CPU (Central Processing Unit) 204, an operating unit 205, and a memory 206. The portable information terminal 101 is a portable terminal such as a cellular phone and a PDA (Personal Digital Assistant).

The radio communication unit 200 communicates with the network 102 by way of a radio communication line. The display unit 201 is a display device that provides the work schedule, contents, facility information and so on to the user. The position information acquisition unit 202 contains a GPS receiver to receive signals sent from the GPS satellite 207 and acquires position information (longitude and latitude) for positioning the portable information terminal from the received signals.

The imaging unit 203 is a digital still camera containing an imaging element. The CPU (Central Processing Unit) 204 controls the overall processing by executing a program stored in the memory 206. The operating unit 205 is buttons and touch panels and so on for the user to make entries. The memory 206 is a non-volatile storage device such as a flash memory for storing image data or facility information, etc.

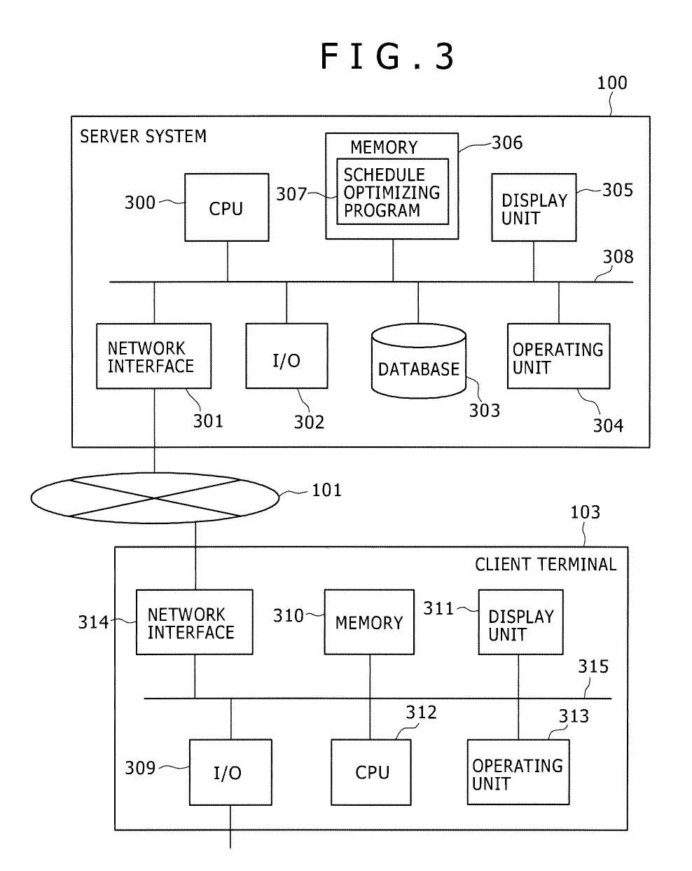

FIG. 3 is a block diagram showing one example of the structure of the server system 100 of the first embodiment.

The server system 100 is a computer containing a processor (CPU) 300, a network interface 301, an IO 302, a database 303, an operating section 304, a display unit 305 and a memory 306. These devices 300 through 306 are coupled by way of a data bus 308.

The processor 300 controls the overall processing by executing programs stored in the memory 306. The network interface 301 couples the server system 100 to other devices. The IO 302 is an interface (for example, USB, etc.) for coupling to external devices. The database 303 is configured from non-volatile storage devices such as magnetic disk devices, and stores information relating to the facility, map information, work schedules, and work results, etc. The operating unit 304 is for example a keyboard or a mouse for making entries by the user. The display unit 305 is a display for showing the processing results and logs, etc.

The memory 306 is a volatile or a non-volatile storage device that stores programs executed by a processor and data used during execution of the relevant program. The memory 306 stores a program 307 for executing a schedule optimizing algorithm. The program 307 is executed by the processor 300.

The client terminal 103 is a computer including a processor 312, a network interface 314, an IO 309, an operating unit 313, a display unit 311, and a memory 310. These devices 309 through 314 are coupled by way of a data bus 315.

The processor 312 exerts overall control by way of executing programs stored in the memory 310. The network interface 315 couples the client terminal 103 to other devices. The IO 309 is an interface (for example, a USB, etc.) for coupling to other devices. The operating unit 313 is a keyboard or a mouse and so on for making entries by the user. The display unit 311 is a display for showing the processing results and logs. The memory 310 is a volatile or a non-volatile storage device that stores programs executed by the processor and data utilized during execution of the relevant program.

The server system 100 and the client terminal 103 are coupled by way of a cable or wireless network 102. The server system 100 or the client terminal 103 sends and receive data by way of a network 102. In the present embodiment, a client terminal 103 is utilized for registering new work other than the schedule generated by the person in charge in the database 303 of the server system 100. The call center operator for example operates the operating unit 313 after receiving a request or a complaint from the customer to generate new work (for example, emergency work other than the schedule) and stores that data in the memory 310. The data is next transferred to the server system 100 by way of the network interface 314 of the client terminal 103, the network 102, and the network interface 301 of the server system 100, and stored in the memory 306 of the server system 100, and registered in the database 303 as new work.

In the present embodiment, the server system 100 sends the work schedule for the relevant day and information on the facility for the work target stored in the database 303 to the portable information terminal 102 by way of the network 102. The workers carrying the portable information terminal, check the information sent from the server system 100, and perform the work as specified in the schedule, and enter the work results in the portable information terminal. The server system 100 for example collects work results and position information acquired by the position information acquisition unit 202 at a specified timing (for example, at specified time intervals) from the portable information terminal 102. The schedule optimizing program 307 within the server system 100 calculates the degree of divergence between the schedule and the achievements by comparing the initial work schedule with the collected work achievements, and decides whether rescheduling is required or not. The schedule optimizing program 307 dynamically optimizes the schedule and stores the new work schedule in the database 303 when the decision was made that rescheduling is required. The schedule optimizing program 307 next sends the new work schedule to the portable information terminal 102. This processing is described in detail later on.

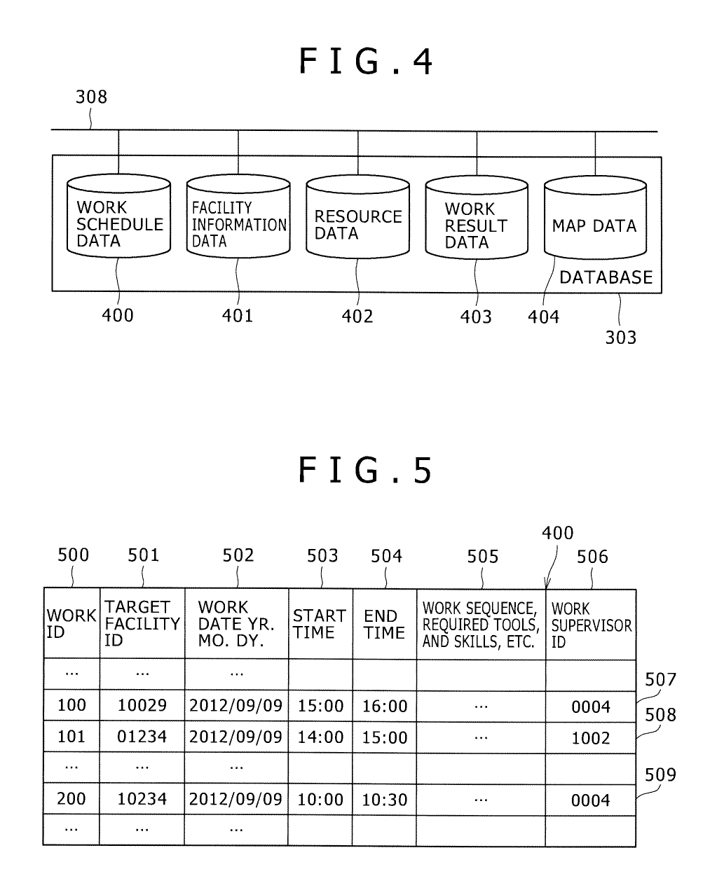

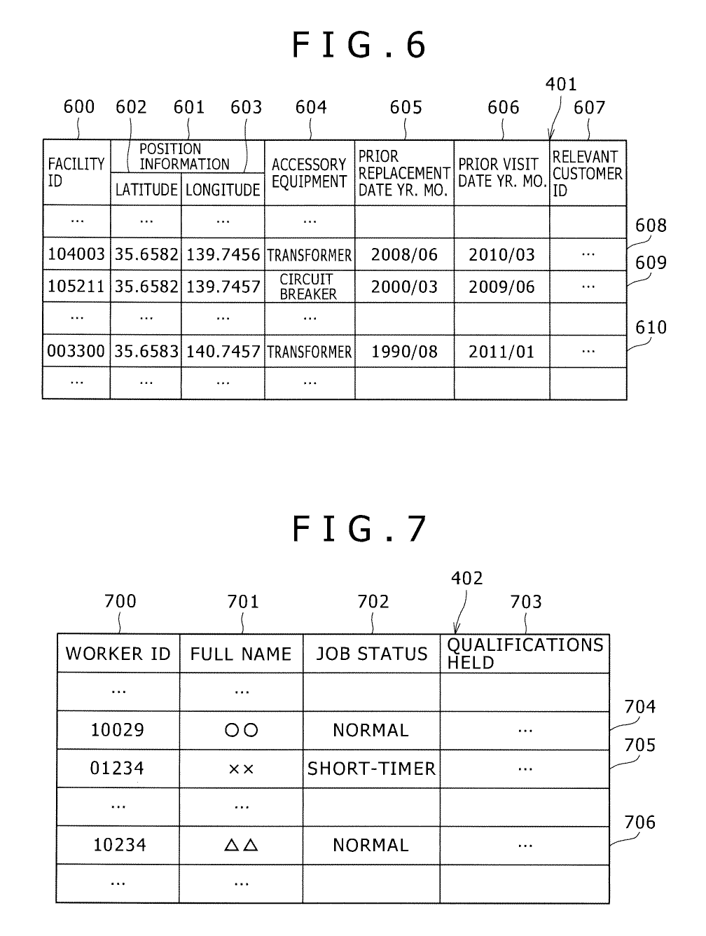

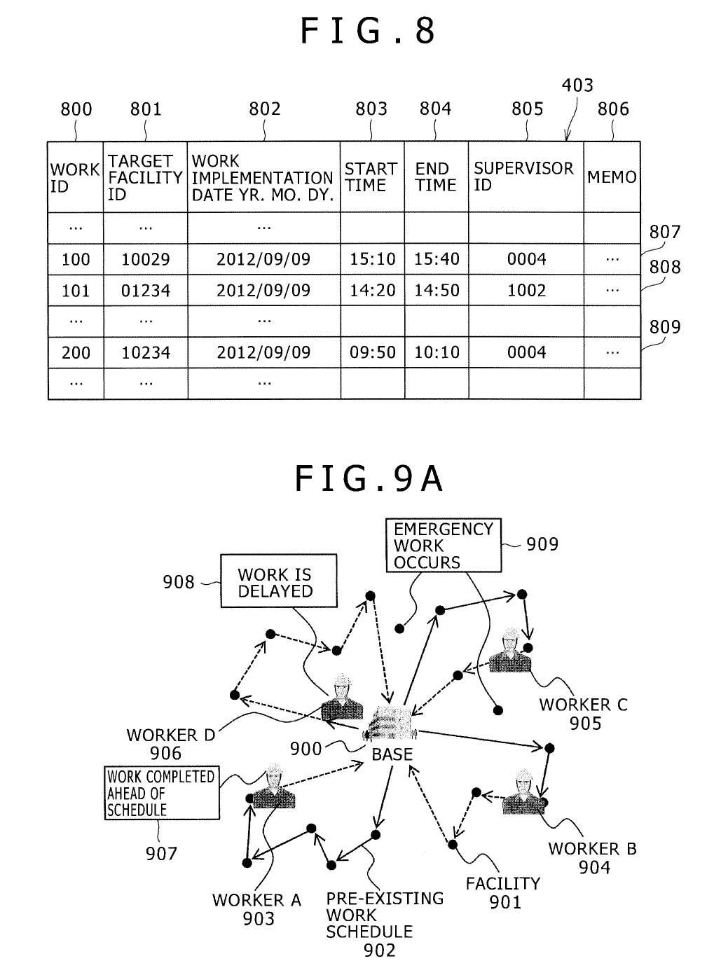

One example of the structure of the database 303 stored within the server system 100 is described while referring to FIG. 4, FIG. 5, FIG. 6, FIG. 7, and FIG. 8.

FIG. 4 is a drawing for describing one example of the structure of the database 303 of the first embodiment. The database 303 includes a work schedule data 400, a facility information data 401, a resource data 402, a work result data 403, and map data 404.

FIG. 5 is a drawing for describing one example of the structure of the work schedule data 400 of the first embodiment.

The work schedule data 400 stores the work schedule such as visits to facilities, inspections, troubleshooting, and customer service, etc. The work schedule data 400 includes the work ID 500, the target facility ID 501, the work date Yr. Mo. Dy. 502, the start time 503, the end time 504, the work sequence, the required tools and skills 505, and the work supervisor ID 506, etc.

The work ID 500 is identification information for uniquely identifying the target work. The target facility ID 501 is identification information for uniquely identifying the facility for the target work. The work date Yr. Mo. Dy. 502, is the year, month, and day that the work was performed. The start time 503 is the schedule time for starting work, the end time 504 is the scheduled time for ending work. The work sequence, required tools and skills 505 are the specified required conditions for executing this work. The work supervisor ID 506 is identification information for uniquely identifying the work supervisor.

The structure of the work schedule data 400 is not limited to the example shown in FIG. 5 and may for example include customer ID for identifying the corresponding customer when the work is customer service.

The data 507, 508, 509 are examples of data stored in the work schedule data 400. The data 507 for example is data relating to the work ID 500; the facility ID serving as the work target is 10029; the work date is Sep. 9, 2012, the start time is 15:00, the end time is 16:00, and the work supervisor ID is 0004. The data 508, 509 in the same way, also indicate schedule relating to the work.

FIG. 6 is a table for describing one example of the structure of the facility information data 401 of the first embodiment.

The facility information data 401 stores the ID for the facility and information relating to that facility. The facility information data 401 includes the facility ID 600, the position information 601, the accessory equipment 604, the prior replacement date Yr. Mo. 605, the prior visit date Yr. Mo. 606, and the relevant customer ID 607.

The facility ID 600 is identification information for uniquely identifying the facility. The position information 601 is a position where the facility is established and is expressed by the latitude 602 and the longitude 603. The accessory equipment data 604 is information relating to transformers, circuit breakers, and arms attached to the electrical pole if the target work is for example for a power distribution facility for the electrical power company. The prior replacement date Yr. Mo. 605, is the year and month that this facility (equipment) was replaced. The prior visit date Yr. Mo. 606, is the year and month that a visit (or inspection) was made to this facility.

The relevant customer ID 607 is identification information for uniquely identifying the customer to whom the target facility supplies electrical power when the target work is for example a power distribution facility for electrical power company.

The structure of the facility information data 401 is not limited to the example shown in FIG. 6 and may include significant information for reference when performing the work.

The data 608, 609, 610 show one example of data stored in the facility information data 401. The data 608 for example stores information relating to the facility ID 104003 and that position information is the latitude 35.6582 and the longitude 139.7456. The accessory equipment is a transformer, and the prior replacement date Yr. Mo. is June 2008, the prior inspection Yr. Mo. is March 2010. The data 609, 610 store information relating to the facility ID in the same way.

FIG. 7 is a table for describing one example of the structure of the resource data 402 of the first embodiment.

The resource data 402 stores the ID of the worker and information relating to the worker. The resource data 402 includes the worker ID 700, the full name 701, the job status 702 and the qualifications held 703.

The worker ID 700 is identification information for uniquely identifying a worker. The full name 701 is the full name of a worker. The job status 702 is the job status (or employment format) of the worker. The qualifications held 703 are the qualifications held by the worker.

The structure of the resource data 402 is not limited to the example shown in FIG. 7 and may for example include information relating to the worker.

The data 704, 705, 706 are examples of data stored within the resource data 402. The data 704 for example stores information relating to the worker having the worker ID 10029; and that the full name of the worker having the worker ID 10029 is ◯◯; and that the job status is ordinary work; and that the worker possesses other job qualifications. The data 705, 706 in the same way store information relating to the worker corresponding to the worker ID.

FIG. 8 is a table for describing one example of the structure of the work result data 403 of the first embodiment.

The work result data 403 stores work results for the work schedule stored in the work schedule data 400 (FIG. 5), and contains the work ID 800, the target facility ID 801, the work date Yr. Mo. Dy. 802, the start time 803, the end time 804, the supervisor ID 805, and the memory 806.

The work ID 800 is identification information for uniquely identifying the work, and utilizes the same identification information as the work ID 500 of the work schedule data 400. The work implementation date Yr. Mo. Dy. 802, is the actual year, month, and day that the work was performed. The start time 803 is the time that the work was actually started, the end time 804 is the time that the work was actually finished. The supervisor ID 805 is identification information for identifying the supervisor who performed the work, and utilizes the same identification information as the worker ID 700 in the resource data 402. The memo 806 is data recorded incrementally during the work.

The structure of the resource data 403 is not limited to the example shown in FIG. 8 and may for example include report item for the work such as the content of the work that was performed.

The data 807, 808, 809 show examples of the data stored in the work result data 403. The data 807 for example shows results from work applicable to work ID 800; the target facility ID is 10029; the work implementation date Yr. Mo. Dy. is Sep. 9, 2012; the work start time is 15:10, the work end time is 15:40; the supervisor ID is 0004, and memos are also stored. The data 808, 809 in the same way also store results of work corresponding to the work ID.

The overall processing of the schedule dynamic optimizing system of the present embodiment was described by way of the above structure.

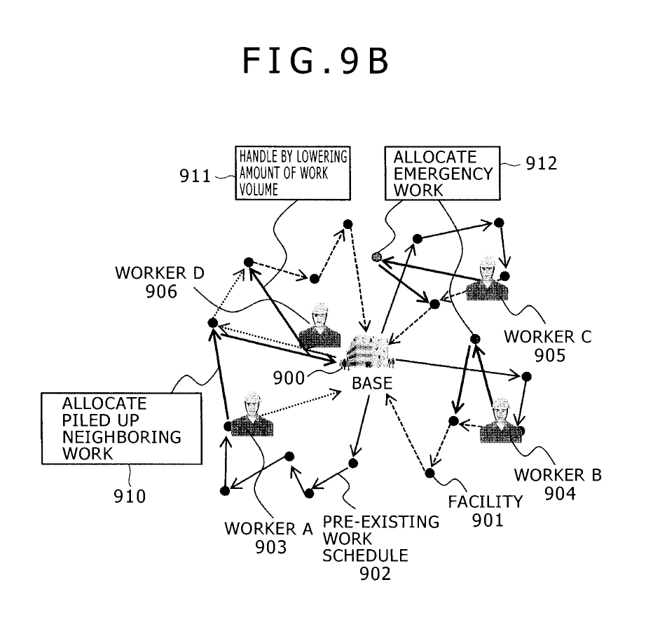

FIGS. 9A and 9B are drawings for describing specific examples of the re-optimizing processing of the first embodiment.

The schedule dynamic optimizing system of the present embodiment dynamically re-optimizes the work schedule according to the circumstances, when work not in the schedule has become necessary or when the work does not proceed according to the schedule, in work schedules such as for visits, inspections, troubleshooting, customer service of power distribution facility (for example, power poles, etc.). FIG. 9A shows the initial work schedule, and FIG. 9B shows the work schedule after optimization.

In the initial schedule as shown in FIG. 9A, four workers (worker A 903, worker B 904, worker C 905, and worker D 906) from base 900 perform the work at the facility 901 according to the work schedule 902. During the course of the work, the worker A 904 for example completes the current day's scheduled work earlier than planned (907); the worker D 906 cannot perform the scheduled work due to on the job delays (908); and instructions for example from a call center issuing emergency work in the vicinity of the worker C 905 that was not planned in the current day's schedule (909).

The existing schedule must be re-planned or re-scheduled when the work other than in the schedule is needed or when the work does not proceed as planned. In the above described cases, the schedule optimizing program 307 decides if rescheduling is needed or not by comparing the current work schedule with the work achievements. If the schedule optimizing program 307 decides that rescheduling is necessary, then re-optimizing is performed so that the overall work time (=cost) becomes minimal. In the work schedule after re-optimizing, there is a time surplus because the worker A 903 completed all of that day's work ahead of time as shown in FIG. 9B. Therefore, a portion of the work that must be performed by the worker D 906 who was unable to do the work due to delays is allocated (910) to the worker A 903. The worker D 906 deals with the delays (911) aided by the partial reduction in the amount of work. The worker B 904 and the worker C 905 are given priority allocation of non-scheduled emergency work that had not been planned for that day (912). The above described optimizing represents no more than an example, the schedule optimizing program 307 optimizes the schedule so that the overall work time is minimized.

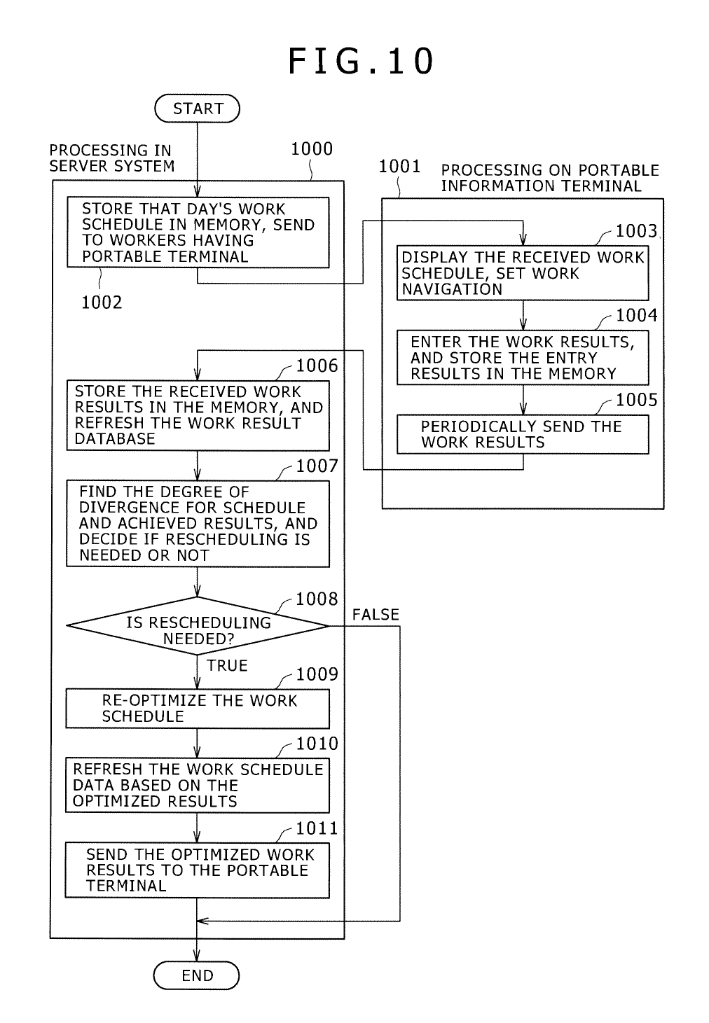

FIG. 10 is a flow chart of the schedule optimizing processing of the first embodiment.

The schedule optimizing processing shown in FIG. 10 is processing that dynamically re-optimizes the schedule according to the work progress status and output that optimized work schedule, when work other than in the schedule is required, or the work does not proceed according to the schedule. The schedule optimizing processing includes the process 1000 (steps 1002, 1006, 1007, 1008, 1009, 1010, and 1011) on the server system 100 side; and the process 1001 (step 1003, 1004, and 1005) on the portable information terminal 101 side. The CPU 300 executes the processing on the server system 100 side, and controls each of the other units by way of the results from this processing. The CPU 204 executes the processing on the portable information terminal 101 side, and controls each of the other units by way of the results from this processing.

The server system 100 first of all, loads the work schedule for that day (or the relevant day) from the work schedule data 400, stores the loaded work schedule in the memory 306, and sends the work schedule (that was) stored in the memory 306 to the portable information terminal 101 possessed by the worker, and instructs the work implementation (step 1002). In this case, the server system 100 loads the information (position information, accessory equipment, etc.) regarding the target facility for the work from the facility information data 401 within the database 303, and sends the loaded data as reference information along with the work schedule to the portable information terminal 101.

The portable information terminal 101 next displays the work schedule for the relevant day sent from the server system 100 on the display unit 201, and performs the work navigation (step 1003). More specifically, in step 1003, the portable information terminal 101 receives the work schedule data sent from the server system 100 in step 1002, stores the received work schedule data in the memory 206, and displays the work schedule on the display unit 201. The position information acquisition unit 202 in the portable information terminal 101 acquires the position information of the portable information terminal 101 by utilizing the signal sent from the GPS satellite 207, and performs navigation from the current location to the position of the facility for the target work. Specific examples of the facility information display and the navigation are described later on.

The worker performs the work in compliance with the work schedule displayed on the display unit 201 of the portable information terminal 101 possessed by the worker, and enters the work results in the portable information terminal 101, to store the entered results in the memory 206 (step 1004). More specifically, in step 1004, the worker performs the work according to the work schedule displayed on the display unit 201, but the work results such as the start time during the start of work and the completion time during the completion of work are entered by utilizing the operating unit 205 on the portable information terminal 101. The portable information terminal 101 stores the entered results in the memory 206. In this case, if an imaging unit 203 (e.g. digital still camera) is for example mounted in the portable information terminal 101, the pictures of the facility are taken using the imaging unit 203, and the captured photographs are stored as recordings of the work. Specific examples of the work result entry are described later on.

The portable information terminal 101 repeatedly (for example at the specified time intervals) sends the work results recorded by the worker to the server system 100 (step 1005). More specifically, in step 1005, the work results accumulated in the memory 206 of the portable information terminal 101 are sent at a specified timing to the server system 100. The timing for sending the information is for example every thirty minutes, and may be set optionally by the administrator, and so on of this system. If the intervals at which the information is sent are long, then the pace that the work progresses cannot be determined in real time, and there are delays in rescheduling. On the other hand if the intervals at which the information is sent are short, then there is communication even if there is no change in the work progress so there is wasted communication between the server system 100 and portable information terminal 101. The portable information terminal 101 may send the work results autonomously or the work results may be sent by user operation, or the work results may be sent according to a request from the server system 100.

The processing on the server system 100 side (step 1006, 1007, 1008, 1009, 1010, and 1011) is implemented next.

The server system stores the position information and work results sent from the portable information terminal 101 into the memory 306, and refreshes the work result data 403 (step 1006).

The server system next finds the degree of divergence between the schedule and achievements by utilizing the contents in the work result data 403 and the work schedule data 400, and decides if rescheduling is needed (step 1007). More specifically, in step 1007, the server system decides if the work is smoothly proceeding on schedule or not. If the server system decides that rescheduling is needed (step 1008) the work schedule is re-optimized (step 1009). The schedule optimizing program 307 executes the steps 1007, 1008, and 1009, and details of the processing are described later on. In step 1008 on the other hand, when decided that rescheduling is not needed, the schedule optimizing program is ended and in this case the worker continues with work according to the initial work schedule.

When the schedule optimizing program 307 re-optimizes the work schedule, the work schedule data 400 is refreshed (step 1010) by utilizing the optimized results.

The server system 100 then loads the optimized work schedule from the work schedule data 400, sends the optimized work schedule to the portable information terminal 101, and gives work instructions (step 1011).

Repeating the above described steps continues the operation of the schedule dynamic optimizing system of the present embodiment.

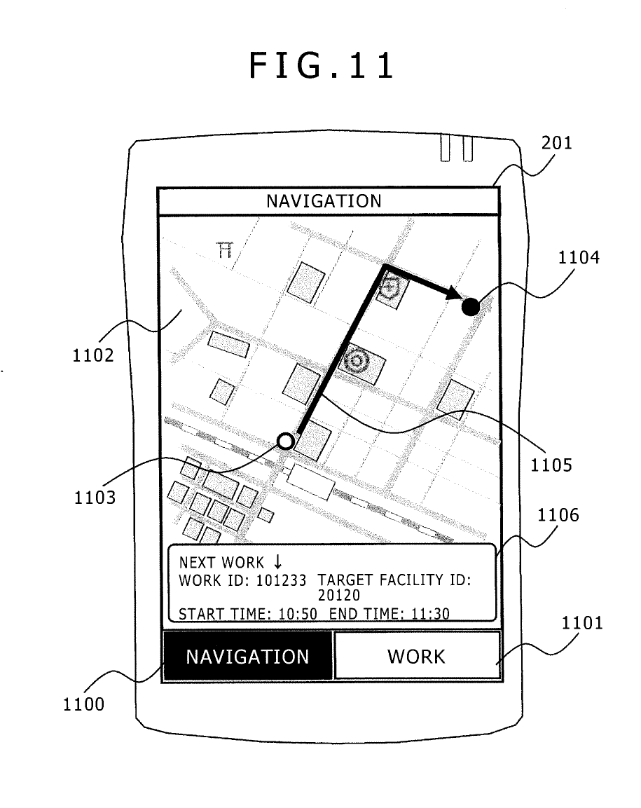

FIG. 11 is an illustration for describing one example of the display shown on the display unit 201 of the portable information terminal 101 of the first embodiment. The display example shown in FIG. 11 is displayed in the step 1003 in FIG. 10.

The display example shown in FIG. 11 is configured so that the screen on the display unit 201 can be switched by using the tabs. These tabs are the “NAVIGATION” tab 1100 for navigation to the work target facility, and the “WORK” tab 1101 for entering the work results. FIG. 11 shows one example of the navigation screen that displays the terminal current location 1103, the next work target facility position 1104, and the path 1105 from the current location 1103 to the target facility 1104 on the map 1102 to assist the worker to move to the target facility 1104. This display example includes detailed information 1106 on the next work. This screen is only an example and a list of work for the relevant day may be shown.

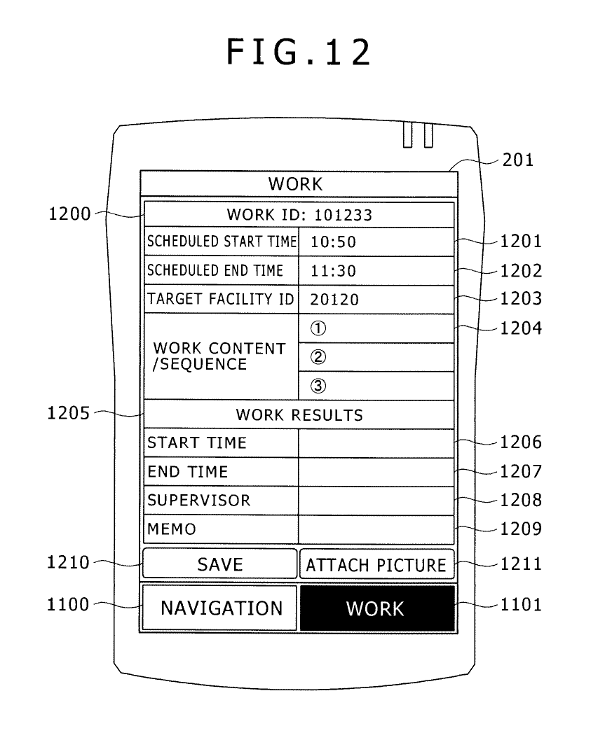

FIG. 12 is an illustration for describing one example of the display shown on the display unit 201 of the portable information terminal 101 of the first embodiment. The display example in FIG. 12 shows the case where the work tab 1101 was selected, and is displayed in the step 1004 in FIG. 10.

The display example shown in FIG. 12 includes a region 1200 showing detailed work information, and a region 1205 for entering the work results. The region 1200 displays detailed work information including the scheduled start time 1201, scheduled end time 1202, target facility ID 1203, and work content/sequence 1204. The region 1205 contains fields provided to entry the work results including the start time 1206, end time 1207, supervisor 1208, and memo 1209. Here for example, the start time is recorded at the start of work, and the end time is recorded at the completion of work.

Various entry methods may be employed on the region 1205. When the portable information terminal 101 for example contains a touch panel, touching an empty field causes a touch entry keyboard to appear to allow entry of letters. If for example, entries can be made by a touch-pen, entries can be made in an empty field by the track made by the pen.

A button 1211 is mounted in order to attach a photograph to this screen. If a digital still camera is for example mounted in the portable information terminal 101, the imaging unit 203 captures a photograph of the facility which can be saved as a record of the work. After entry of the required results, the entry results are stored in the memory 206 within the terminal by operating the SAVE button 1210. The screen shown here is nothing more than an example and a portion of the items may be omitted, and other items may be displayed.

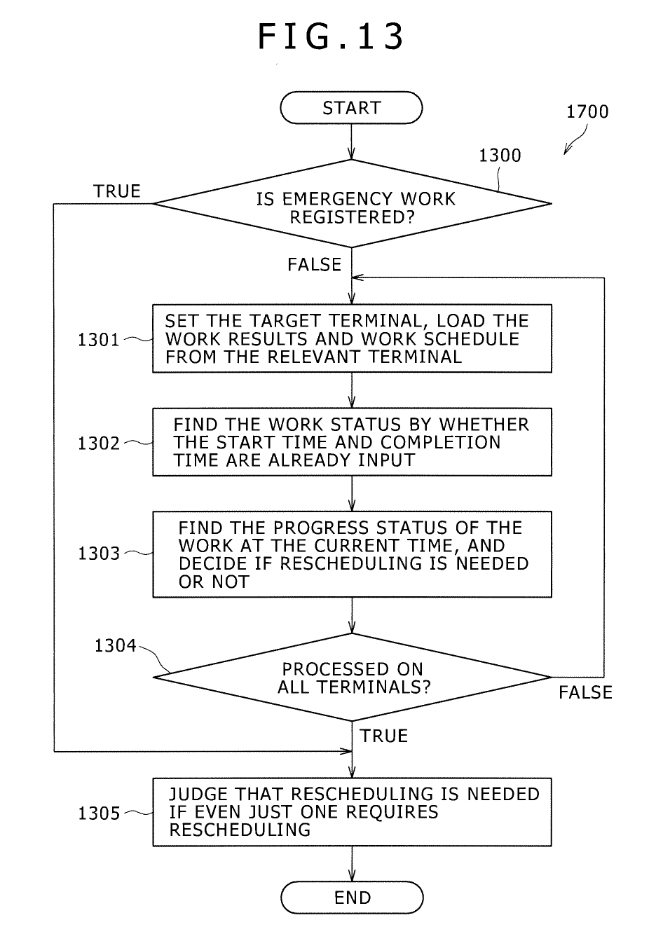

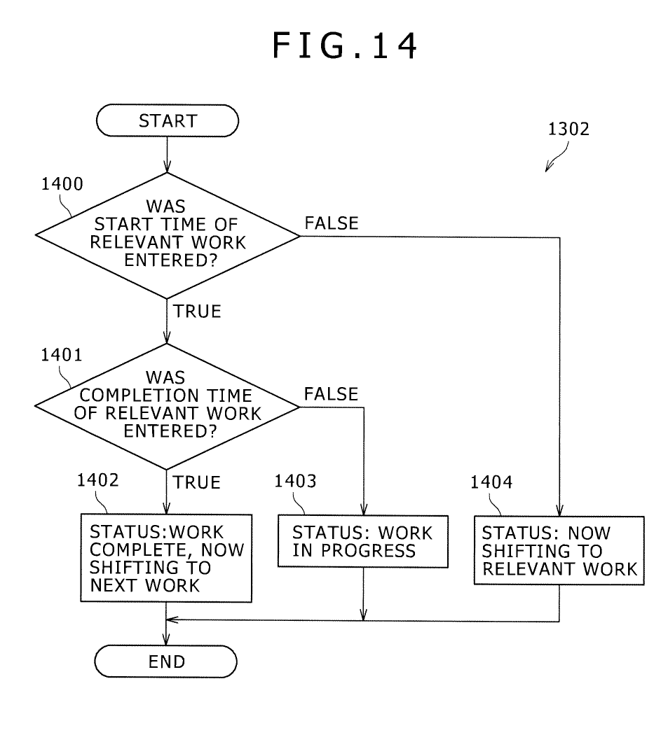

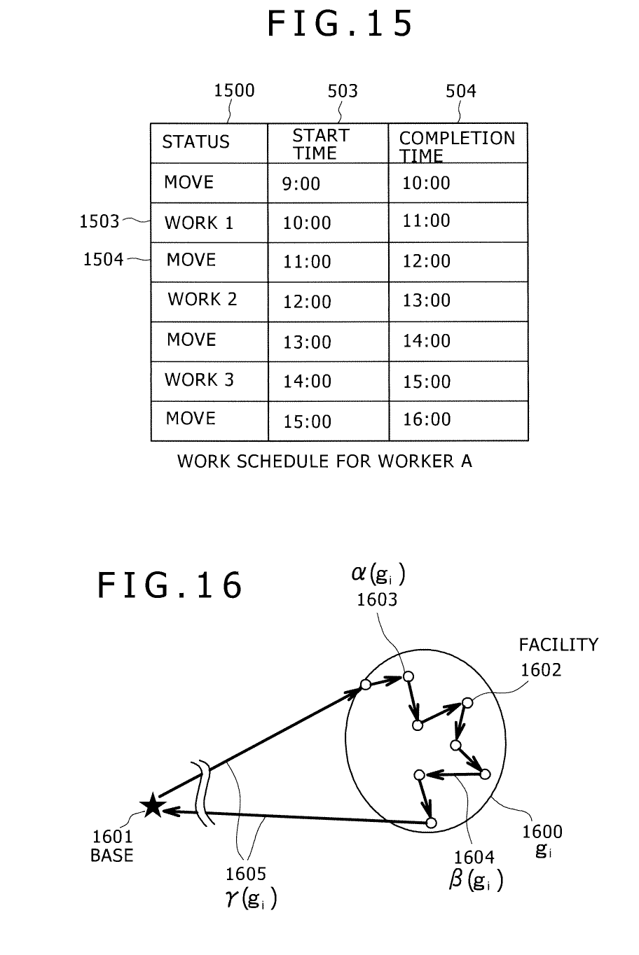

Next, the processing in step 1007 in the flow chart shown in FIG. 10 or namely the processing to utilize the work result data and work schedule data to find the degree of divergence between the schedule and achievements and make a rescheduling decision is described in detail while referring to FIG. 13, FIG. 14, and FIG. 15.

FIG. 13 is a flow chart showing the rescheduling decision processing of the first embodiment. The rescheduling decision processing shown in FIG. 13 is performed by executing the specified program by the processor 300 in the server system 100.

The processing first of all decides if the emergency work is registered or not (step 1300). For example if the contact personnel at the call center is contacted by a customer regarding a request or an accident and new work has now become necessary, the contact personnel operates the operating unit 313 of the client terminal 103 to generate new work data (data for one entry of work schedule data 400). The client terminal 103 stores the generated work data into the memory 310 and transfers the generated work data to the server system 100 by way of the network interface 315, the network 102, and the network interface 301. The server system 100 stores the data transferred from the client terminal 103 into the memory 306, and refreshes the contents of the work schedule data 400 in the database 303.

The work data newly registered in this way is the emergency work that is not contained in the initial work schedule. In step 1300, a decision is made on whether this type of non-scheduled emergency work is registered or not. If the emergency work was registered, a decision is made that rescheduling is required and the processing proceeds to step 1305. On the other hand, if the emergency work was not registered, the processing proceeds to step 1301, and whether rescheduling is required or not is decided according to the progress status of the work (steps 1301 through 1303).

More specifically, if the emergency work was not registered, a terminal serving as the processing target for the rescheduling decision processing is set, and the work schedule for the relevant terminal is loaded from the work schedule data 400, and the work results are loaded from the work result data 403 (step 1301).

Next, the work status is found by way of the start time and completion time that were input (step 1302).

FIG. 14 is a flow chart showing in detail the processing in step 1302.

First of all a decision is made on whether or not the start time has already been input for the work scheduled at the current time that was judged as requiring rescheduling (S1400). If the start time has not yet been entered, then the relevant work has not yet been started (for example, moving to the facility to perform the relevant work) (status 1404). On the other hand, if the start time of the relevant work has been entered, a decision is made on whether or not the completion time has been input (step 1401). If the completion time of the relevant work has not been entered, then the relevant work is currently performed (state 1403). If the start time and the completion time of the relevant work have been entered, the relevant work has already been completed (for example, currently moving to next facility to perform work (status 1402)). The work status scheduled at the current time is in this way found in step 1302 by way of the start time and the end (completion) time.

The processing next compares the work status found in step 1302 with the work that is scheduled at the current time and finds the progress status of the work, and decides whether or not rescheduling is needed (step 1303). Namely, in step 1303, a decision is made on whether the work is behind schedule, ahead of schedule or mostly on schedule.

By including the work start time and the end time in the work schedule data 400 and work result data 403 and comparing the work schedule data 400 with the work result data 403, the progress status of the current work can be easily and accurately found.

When the processing in steps 1301 through 1303 is executed for all terminals (step 1304) and even just one terminal is decided to require rescheduling, or emergency work was registered, a decision is made that rescheduling is required (step 1305).

The process for making the rescheduling decision is specifically described while referring to FIG. 15. The drawing in FIG. 15 is an excerpt of a portion of the work schedule data 400 of the worker A, and includes the start time 1501 and the completion time 1502. The status 1500 is attached for purposes of convenience for simplifying the description.

In the work schedule shown in FIG. 15, when a decision on whether rescheduling is needed for example at 10:30, the work applicable to the current time 10:30 is “Work 1” 1503. The processing first of all finds the work status of Work 1 in step 1302.

If no start time for Work 1 has been entered at the current time 10:30, the Work 1 has not yet started so movement to the facility for performing Work 1 (work status 1404) is currently in progress. On the other hand if the completion time has been entered then the Work 1 is already complete, and movement to the facility to perform the next Work 2 (work status 1402) is in progress. If the start time has been entered, but the completion time has not been entered, the work on the Work 1 (work status 1403) is currently in progress.

Next in step 1303, the progress of the work status is found, and a decision is made on whether rescheduling is needed or not.

A tolerance time offset (e.g. 10 minutes) for example is set in advance for the work schedule as a decision threshold value for the start time and completion time. This tolerance time (permissible time) may be set to an optional figure by the system administrator. In other words, the start time for Work 1 is scheduled as 10:00 so that if the work can be started between a tolerance time (permissible time) slots from 9:50 to 10:10 then the work is proceeding on schedule. Likewise for the completion time, if the work can be completed within the tolerance time (permissible time) slot of 10:50 to 11:10 then the work is proceeding on schedule.

In the status 1404 in step 1302 for example, or namely when the Work 1 has not yet been started, the work has not started at the current time of 10:30 so the work start time is not within the tolerance time (permissible time) slot 9:50 to 10:10. Therefore, the work is delayed and a decision is made that rescheduling is needed. Even if Work 1 has not been started at the current time of 10:05, the current time is still within the tolerance time (permissible time) slot of 9:50 to 10:10 so the work is possibly proceeding on schedule and a decision is therefor made that rescheduling is not needed.

In the status 1402 in step 1302, or namely when the Work 1 has already completed, the work has been completed earlier than the tolerance time (permissible time) slot 10:50 to 11:10. The work was completed earlier than scheduled so a decision is made that rescheduling is needed. Even in this same status 1402, if the Work 1 was completed for example at 11:20, then the work was not completed within the tolerance time (permissible time) slot 10:50 to 11:10 so a decision is made that the work is delayed.

In the status 1403 in step 1302, or namely in a state where performing the work 1 at a current time of 10:30; the work is in progress though at a work schedule of 10:30 so the work is being performed as scheduled and a decision is made that rescheduling is not needed. In the same way, when for example the Work 1 is in progress at a current time of 11:20, the work has not been completed within a tolerance time (permissible time) slot of 10:50 through 11:10 so a decision is made that the work is delayed.

In the rescheduling decision processing as described above, the progress for the work and work status are found by utilizing the work schedule, work results, and current time, to decide whether rescheduling is needed or not.

Next, the processing of step 1009 in the flow chart shown in FIG. 10 or in other words, the work schedule re-optimizing processing executed by the schedule optimizing program 307 is described in detail while utilizing FIG. 16 through FIG. 22 and by utilizing formulas 1 through 6.

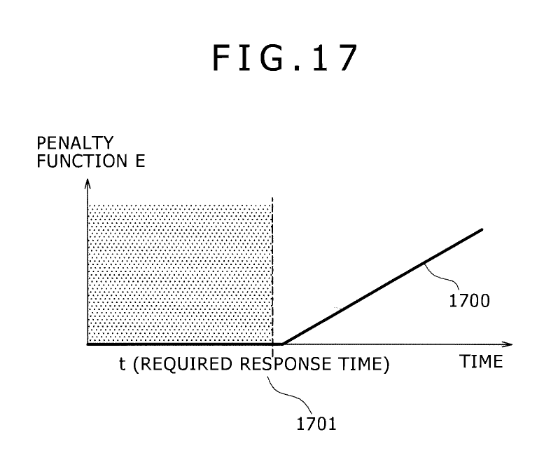

When work that is not in the schedule has become necessary or when the work is not proceeding according to schedule, the schedule optimizing program 307 of the present embodiment dynamically re-optimizes the schedule so as to minimize the overall work time (namely, cost) while satisfying the limiting conditions. In other words, the schedule optimizing program 307 finds a work schedule that minimizes the cost to solve the re-optimizing problems. The target function for minimizing and the work cost model are first of all described while utilizing FIG. 16 and FIG. 17 and utilizing formulas 1 through 5.

FIG. 16 is a drawing for describing the work group gi (1600). The work group gi (1600) is one work group including the facility 1602 where the work is performed in the period from the worker leaving the base 1601, performing the work, and returning to the base 1601. Therefore, one work group gi is can be expressed as a plurality of facility pj clusters and can be expressed by formula 1. In the formula 1, M is the number of facilities contained in the group gi.

[Formula 1]

gᵢ={p₀,p₁, . . . pⱼ, . . . p_{M-1}} (1)

There are a plurality of work groups in the area that is the responsibility of the base. The cluster G of Ng number of work groups gi can be expressed by the formula 2.

[Formula 2]

G={g₀,g₁, . . . gᵢ, . . . g_{N}_{_{g}}₋₁} (2)

The work cost C(gi) for the work group gi can be calculated by formula 3 under these types of conditions. In other words, the work cost C(gi) can be calculated by the sum of the time α(gi) 1603 needed for work at the facility, the time β(gi) 1604 needed for moving among facilities, and the roundtrip movement time γ(gi) 1605 between the base and the group gi (See FIG. 16).

[Formula 3]

C(gᵢ)=α(gᵢ)+β(gᵢ)+γ(gᵢ) (3)

The work cost can be accurately calculated by calculating the sum of the time α(gi) needed for work at the facility, the time β(gi) needed for moving among facilities, and the roundtrip movement time γ(gi) between the base and group gi to find the work cost C(gi).

The time α(gi) needed for work at the facility can be calculated by finding the difference between the start time 503 and the end time 504 of the work stored in the work schedule data 400 in the database 300. More specifically, by calculating the difference between the start time and end time of the work at each facility within the group, and summing the calculated differences, the time α(gi) 1603 needed for work at the facility can be calculated.

The time β(gi) for movement among facilities and the roundtrip movement time γ(gi) between the base and group gi are movement times that can be calculated based on the shortest movement distance among the inspection routes among the facilities requiring work within the work group gi. The problem of finding the shortest inspection (route) distance is a typical traveling salesman problem and when the number of facilities to visit is large, finding an exact solution is difficult. Solution methods for finding an approximate solution in a realistic time (such as the local search method, genetic algorithms, and simulated annealing, etc.) have been proposed. The movement time in the present embodiment can be calculated using these methods but since there are at most only a few dozen facilities included in one work group, the movement time can be found at high speed by an approximate solution.

A target function for minimizing the cost as defined by the work cost model described above can be expressed as in formula 4. A first term in formula 4 expresses the total of the work cost for the entire work group contained in the area that is the responsibility of the base, and finds the work group cluster G that serves to minimize the total sum of the work cost. The E (gi) in the second term in formula 4 expresses the penalty function. The penalty function is a penalty applied the group gi does not fulfill the limiting conditions.

$$\begin{matrix}[ Formula 4 ] & \\ f = {\sum }_{i = 0}^{{N}_{g} - 1} C ( {g}_{i} ) + {\sum }_{i = 0}^{{N}_{g} - 1} E ( {g}_{i} ) & ( 4 )\end{matrix}$$

FIG. 17 is a graph for describing one example of the penalty function for the facility.

In this case, the penalty function is expressed by the line 1700. A required response time t 1701 is set in each facility, and the work must be performed within that time setting. So in the case for example of the facility shown in FIG. 17, the penalty function up to the required response time t 1701 is 0 but when the required response time t 1701 is exceeded, values are linearly applied relative to the excess time. In other words, this penalty function expresses a penalty that becomes larger as the specified time is exceeded. Setting this type of penalty function in each facility and obtaining the total penalty value for facilities within the work group is shown in E (gi) in Formula 4. The target function therefore serves as a function for minimizing the total for the cost and penalty, and finding a group cluster G that minimizes the cost while meeting the required response time for facilities within each group. The penalty function is not limited to the example shown in FIG. 17, and may for example even be a function that establishes a time band (start time and end time) for performing the work, and may be a function that increases or decreases non-linearly, rather than making linear increases or decreases.

Utilizing a penalty function in this way, allows setting conditions that are otherwise hard to unify.

The condition shown in formula 5 may also be set as another limiting condition. The T in formula 5 expresses the time allowable for work in one day by a worker in charge of the work group gi. The worker leaves the base, moves to the facility and performs the work, and finally returns to the base. The total work time for one work group must be the same or lower than the work hours of the workers in one day.

[Formula 5]

C(gᵢ)≦T (5)

Restricting the total work time for one work group to the same or fewer hours for the workers in one day prevents generating an impossible work schedule and suppresses having to reorganize the work schedule.

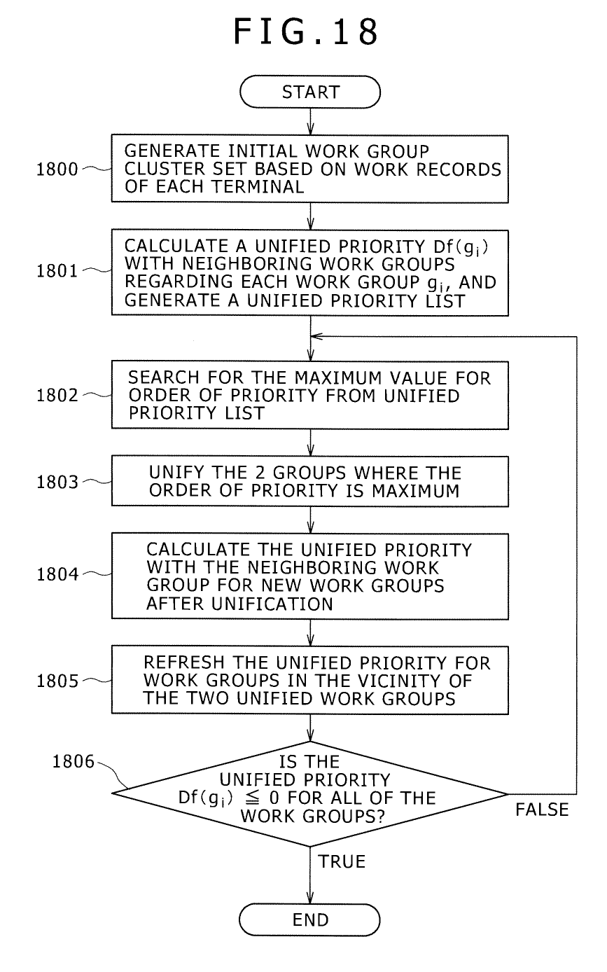

The processing in step 1009 for minimizing the target function and for re-optimizing the work schedule as described above is described in detail while referring to FIG. 18 through FIG. 23, and formula 6.

FIG. 18 is a flow chart showing in detail the work schedule re-optimizing processing (step 1009).

Work schedule re-optimizing here takes the approach of generating an initial group cluster by utilizing the work status and progress status found from the rescheduling decision (steps 1007 and 1008), and obtaining a final schedule by unifying the work groups in sequence. In this case, a unified priority is set for the work group and the work groups are unified in the order that the work cost becomes smaller. A description of the work schedule re-optimizing is described according to the steps in the flow chart.

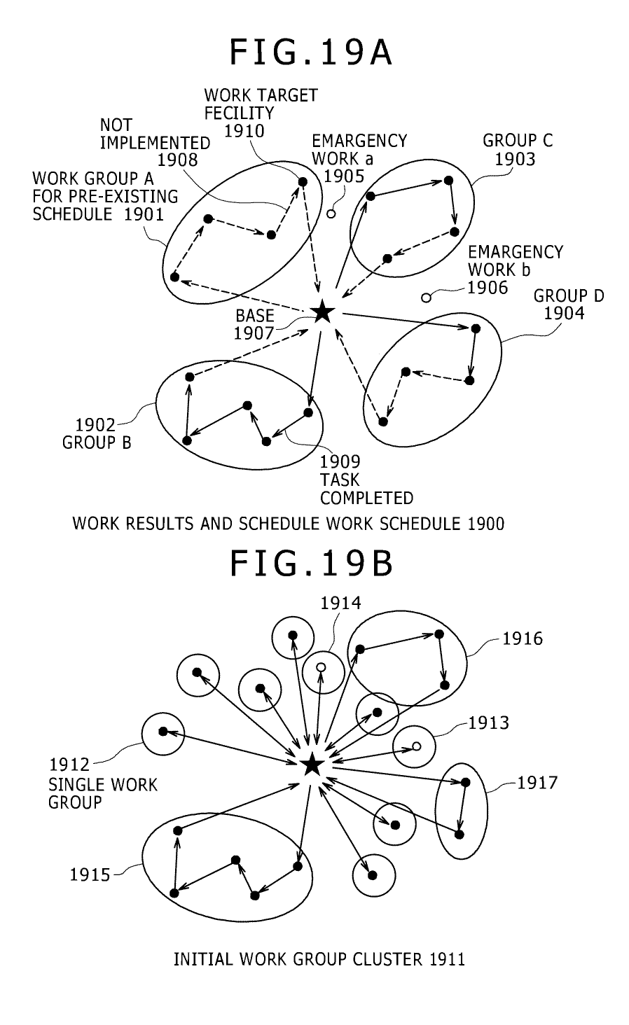

The processing generates the initial work group cluster (step 1800) based on the work achievements in each terminal. Here, the processing contents in process step 1800 are described by utilizing a specific example. FIGS. 19A and 19B are drawings showing a specific example of the process step 1800. The process steps 1007 and 1008 decide the work status and progress status of each worker by utilizing the work results sent from the portable information terminal 101 held by each worker, and the work schedule data stored in the database.

As shown for example in FIG. 19A, the initial work schedule 1900 for the area that is the responsibility of the base 1907 includes four scheduled groups comprised of the work group A 1901, the work group B 1902, the work group C 1903, and the work group D 1904. Among the work schedule, the work expressed by a solid line 1909 is complete, and the work expressed by the dashed line 1908 is incomplete. Moreover, the non-scheduled emergency work a 1905 and emergency work b 1906 that are not in the initial work schedule are occurring in this figure.

An initial work group cluster is therefore generated as shown in 1911 from the initial work schedule and work progress status shown in the work schedule 1900 as shown in FIG. 19B. Facilities where work has not yet been performed are separately set as a single work group 1912. Facilities requiring non-scheduled emergency work a and b are set separately as single work groups (1913, 1914). On the other hand, facilities where work is already complete and facilities where work is in progress are collectively set as one work group. In group C 1903 for example, facilities where work is complete and facilities where work is in progress are collectively placed in a single group 1916. In the work group B 1902 and the work group D 1904 facilities where work is complete and facilities where work is in progress are collectively placed by group in the same way in the work groups 1915, 1916. A cluster of these work groups is the initial work group cluster 1911.

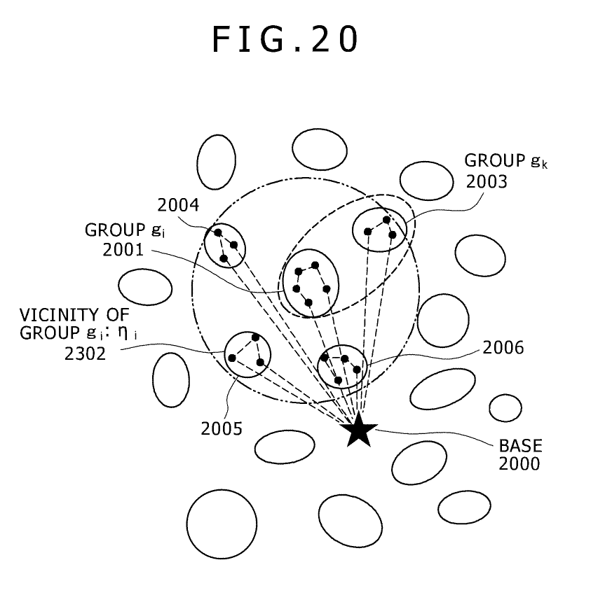

After generating the initial work group cluster 1911, the processing calculates the unified priority Δf of each work group gi with the other work groups in the vicinity and makes a unified priority list (step 1801). The work groups in the vicinity of work groups are sufficient for calculating the unified priority Δf of each work group gi. The method for calculating the unified priority is described while referring to FIG. 20 through FIG. 22 and formula 6.

The unified priority Δf (gi) of each work group gi can be calculated by formula 6.

$$\begin{matrix}[ Formula 6 ] & \\ Δ f ( {g}_{i} ) = {max}_{{g}_{k} ∈ {η}_{i}} ( Δ {C}_{{g}_{i - k}} + Δ {E}_{{g}_{i - k}} ) & ( 6 )\end{matrix}$$

Here, ηi indicates the spatial vicinity of the work group gi. The ΔCgi-k shown in formula 6 is the difference in inspection (route) costs before and after unification of the work groups gi and gk. The ΔEgi-k is the difference in penalty values before and after unification of the work groups gi and gk.

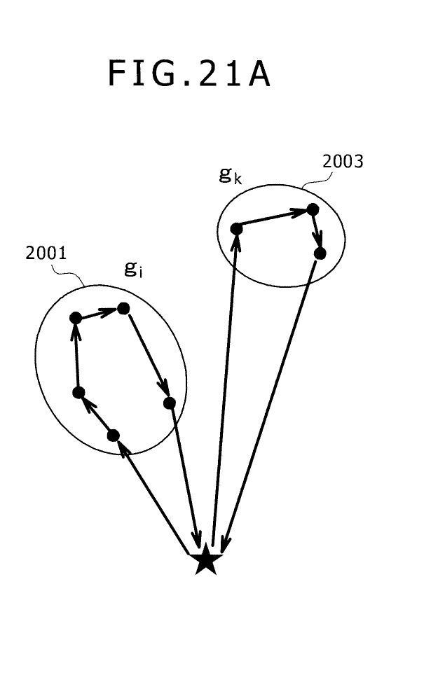

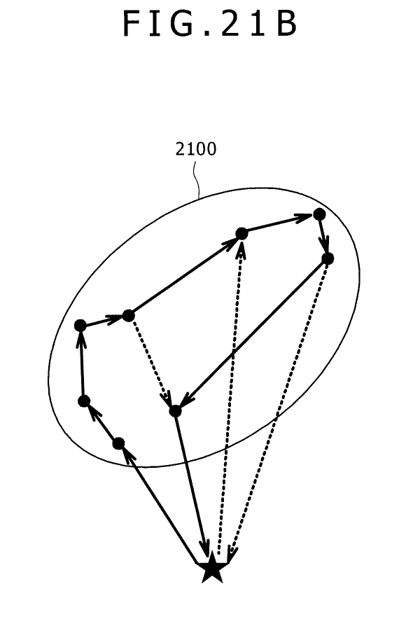

Formula 6 is described next while referring to FIG. 20, FIG. 21A, and FIG. 21B. To find the unified priority of the work group gi requires considering unifying with which group among the groups 2003, 2004, 2005, and 2006 within the neighboring ηi 2002 of the group gi, will set the formula 5 serving as the target function to a minimum. As shown in FIG. 21A for example, unifying the group gi 2001 and group gk 2003 can generate a group 2100 after unification as shown in FIG. 21B, and reduce the inspection route. The difference before and after unification in the sum of the cost and penalty values is calculated to find the target function.

If there is a positive difference before and after unification, there is reduction in the target function due to unification. If there is a negative difference before and after unification on the other hand, then there is no reduction in the target function due to unification. This type of processing is also performed on the groups 2004, 2005, and 2006, and among these groups, the combination of groups having the largest decrease in the target function and that amount of reduction are set as the unified priority for the work group gi.

The candidate unification groups are limited to the neighboring of the group gi because setting the total responsible area for the candidate unification group gk, also causes the combinations of groups with a small cost reduction due to unification to be calculated so that the search range becomes too large and is not practical to use. The candidate unification group gk is therefore limited to the neighboring ηi of the target group gi.

The unified priority is also calculated for all groups gi contained in the work group cluster G, and a unified priority list is generated based on those results.

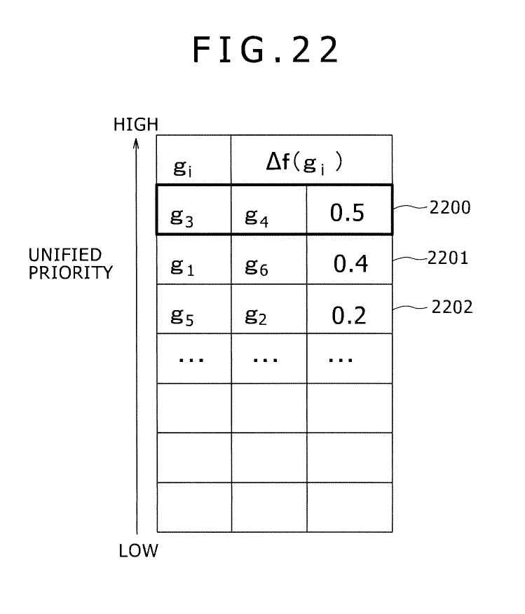

FIG. 22 is a drawing for describing one example of the unified priority list. In the unified priority list shown in FIG. 22, the candidate unification group combinations 2200, 2201, and 2202 are arranged in order of a large Δf (gi). Among these, the maximum value of Δf (gi) is Δf (g3). This result indicates that currently in the range of responsibility, the group combination due to unification of two groups that can reduce the target function (that can be reduced in man-hours and time) to the smallest figure is the combination resulting when group g3 and group g4 are unified. The combination of the groups g3 and g4 therefore has the highest unified priority. In the steps from here onward, actual groups are unified based on the unified priority list that was generated.

Next, a search for the order of priority with the maximum value is made from the unified priority list (step 1802). In the case of FIG. 22, the maximum value is Δf (g3).

The two groups having a maximum priority value are next unified (step 1803). In the example shown in FIG. 22, group g3 and group g4 are unified. Unifying group g3 and g4 makes the target function 0.5 smaller than before unification.

The unification of two groups forms a new work group gi′ so that the unified priority Δf (gi′) is calculated for the new work group gi′ and is reflected in the unified priority list (step 1804).

In the example shown in FIG. 22, a new group g3′ is generated by unifying group g3 and group g4 so that a unified priority Δf (g3′) is calculated for the new group g3′.

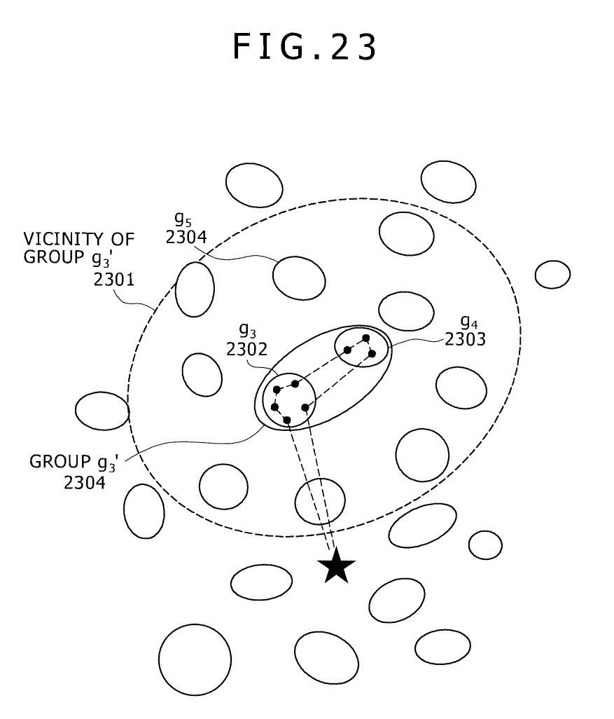

The structure of the work group cluster G changes after unifying the groups so that the unified priority of the work groups in the vicinity of the group g3′ after unification must also be refreshed (step 1805). The refreshing of the unified priority in the vicinity of work groups is described by utilizing the specific example shown in FIG. 23. A new group g3′ (2304) is generated by unifying the group g3 (2302) and group g4 (2303) in the unified priority list shown in FIG. 22. In this case, since the group structure has changed from the structure before unification, the unified priority Δf is recalculated for the work group present in the vicinity (or neighboring area) 2301 of the group g3′.

By repeating the above processing so that the unified priority Δf (gi) for all work groups is 0 or less, or namely until the target function from unification of groups can become no more smaller, a final work schedule can be generated.

By calculating the unified priority for work group combinations and utilizing the calculated unified priority to establish a unified work group, a work group can be reliably set that serves as a basis for cost reductions in this way.

The effects on the vicinity due to unification can be accurately judged by refreshing the unified priority of work groups in the vicinity (neighborhood) of the unified work groups. Unifying the work groups, also allows efficiently obtaining a work schedule capable of large reductions in overall cost. Also, spatially limiting the search range to neighboring areas allows high speed processing. Optimized initial (or default) values can then be generated according to the current work progress status, and based on the work achievements up to the present, optimized work schedules for the future can be generated. New overall schedules can also be generated in the event that initial values cannot be established.

In the step 1800 to generate an initial work group cluster, the accumulated work achievements were utilized to generate the initial work group cluster. However, an initial work group cluster can be generated where all the facilities are set as a single work group, and when group unification processing starts from that state, a normal work schedule can be generated rather than a re-optimized schedule. The schedule optimizing program 307 can therefore be created for normal work schedules (for example, daily work schedules, etc.). Of course when creating a normal work schedule, the local search methods, genetic algorithms, and simulated annealing methods serving as approximate solutions for typical combination optimizing problems may also be utilized, and the methods disclosed in Japanese Unexamined Patent Application Publication No. 2003-26335 may also be utilized.

The first embodiment as described above can dynamically optimize the initial work schedule according to the progress status of the work schedule, when work not in the scheduling has become necessary or when the work does not proceed according to the schedule. When optimizing of the work schedule, unifying those work groups having a maximum cost reduction will allow efficiently obtaining a work schedule capable of large reductions in overall cost. Also, spatially limiting the search range to neighboring areas allows high speed optimizing processing. Generating optimized initial (or default) values according to the current work progress status allows finding optimized work schedules for subsequent use that are derived from past achievements attained up to the present.

The schedule dynamic optimizing system of the first embodiment can be applied to work schedules such as for visits, inspections, troubleshooting, and customer service of power poles, and so on for the power distribution facility. However the system of the embodiment is not limited to this example and can also be utilized in fields having many target objects, facilities and customers over a wide area and requiring performance of work for those objects, facilities and customers (e.g. physical distribution services such as home deliveries).

### Second Embodiment

The second embodiment substitutes the portable information terminal 101 of the above described first embodiment into an on-board car navigation device mounted in vehicles. Moving by vehicle is ideal for performing work on a large number of target facilities located over a wide area. Therefore, utilizing car navigation devices is an ideal way to achieve a schedule dynamic optimizing system.

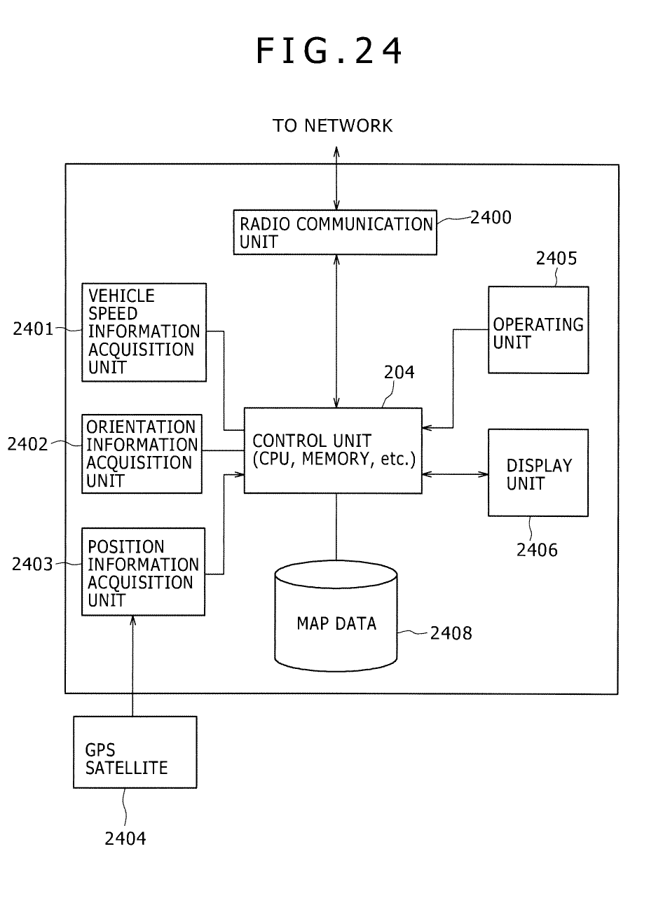

FIG. 24 is a block diagram showing one example of the structure of the on-board car navigation device of the second embodiment.

The on-board car navigation device includes a radio communication unit 2400, a display unit 2406, a position information acquisition unit 2403, an orientation information acquisition unit 2402, a vehicle speed information acquisition unit 2401, a control unit 2407, an operating unit 2405, and map data 2408.

The radio communication unit 2400 communicates by way of a radio communication channel with the network 102. The display unit 206 is a display device that displays navigation via a map, work schedules, content, and facility information to the user. The position information acquisition unit 2403 contains a GPS receiver to receive signals sent from the GPS satellite 2404, and acquires position information (longitude and latitude) for positioning the portable information terminal from the received signals. The orientation information acquisition unit 2402 includes a gyro sensor and measures the orientation of the car in which the car navigation device is mounted. The vehicle speed information acquisition unit 2401 detects the speed of the vehicle in which the car navigation device is mounted. The control unit 2407 includes a processor to execute the program and a memory to store the program, and controls the navigation device by executing the specified program.

The operating unit 2405 is buttons and touch panels and so on for the user to make entries. The map data 2408 is stored in a non-volatile storage medium such as a HDD (Hard Disk Drive), SD card, DVD-ROM or a CD-ROM.

Apart from the above described structures, a specified interface (such as a USB cable) can couple the car navigation device to a digital still camera so that photographs captured with the digital still camera can be uploaded to the server system 100. In this way, photographs of the facility can be linked to the work results and stored.

The results from the work registered in the first embodiment may for example be input using an operating unit 2405 (such as a touch panel) mounted along a display unit 2406.

In the above type of structures, a schedule dynamic optimizing system may be configured by utilizing on-board car navigation device instead of the portable information terminal 101 described in the first embodiment. The structure of the server system 100 and the system processing are identical to the description in the first embodiment so a redundant description is omitted.

Utilizing the on-board car navigation device permits obtaining traffic information such as on traffic congestion from the VICS (Vehicle Information Communication System) {VICS is a registered trademark}, and allows optimizing the work schedule to take that traffic information into consideration.

The present invention was described in detail while referring to the accompanying drawings however the present invention is not limited to these types of specific structures and may include all manner of changes and equivalent structures falling within the scope and spirit of the accompanying claims.

What is claimed is:

1. A scheduling management system to generate a work schedule containing a plurality of work targets,
wherein the scheduling management system includes a computer, and a plurality of terminal devices coupled to the computer,
wherein the work targets are classified into work groups including at least one work target,
wherein the computer includes:
a storage unit that retains position information for the work target, a work schedule for the work target, and work results sent from the terminal device;
a calculation unit that calculates the cost of work for the work target based on the position information, the work schedule, and the work results;
a decision unit that decides if reorganization of the work schedule is needed or not based on the position information, the work schedule, and the work results;
a schedule generator unit that generates a work schedule based on the decision results from the decision unit and the cost calculated by the calculation unit,
wherein the terminal device includes:
a display unit that displays the work schedule sent from the computer;
an operating unit that enters the work results; and
a communication unit that sends the work results to the computer,
wherein the decision unit finds the progress of the work by comparing the work schedule with the work results and decides if reorganizing of the work schedule is needed or not based on the degree of divergence between the work schedule and the progress status of the work,
wherein the calculation unit calculates the cost for a unified work group formed from the work groups, for each combination of work groups when the decision unit decides that reorganization of the work schedule is needed, and
wherein the schedule generator unit compares the calculated costs and reorganizes the work schedule by unifying the work groups based on results from the cost comparison.

2. The scheduling management system according to claim 1,
wherein the schedule generator unit sets the priority of the work group combinations for unification based on results from comparing the calculated costs, and unifies the two work groups having a maximum priority level, and
wherein the calculation unit calculates the cost of the unified work group.

3. The scheduling management system according to claim 2,
wherein the schedule generator unit refreshes the priority of other work groups of the unified work group.

4. The scheduling management system according to claim 1,
wherein the work schedule includes the scheduled start time and scheduled end time for the work,
wherein the work results include the start time and the end time for the work.

5. The scheduling management system according to claim 4,
wherein the decision unit finds the work progress by comparing the scheduled start time and scheduled end time for the work contained in the work schedule, with the start time and end time contained in the work results.

6. The scheduling management system according to claim 1,
wherein the schedule generator unit unifies the work groups to achieve a minimum cost.

7. The scheduling management system according to claim 1,
wherein the calculation unit calculates the cost of the work group by summing the time required for the worker to perform work on the work target contained in the work group; the time required for the worker to move between work targets contained in the work group; and the time required for the worker to make a round-trip movement between the base and the work group.

8. The scheduling management system according to claim 7,
wherein the schedule generator unit unifies the work groups so that the cost for the one work group is within the work hours of the worker in charge of the work of the work group.

9. The scheduling management system according to claim 1,
wherein the calculation unit collects work targets whose work is completed and work targets whose work is being performed, into one work group, and generates a single initial work group for each work target whose work has not been started, and calculates the cost when the generated initial work groups are unified.

10. A scheduling management method to generate a work schedule including at least one work target,
the scheduling management system including a computer, and a plurality of terminal devices coupled to the computer,
the work targets being classified into work groups, and
the computer including a processor to execute the program and a memory to store the program,
the scheduling management method comprising:
a first step of accepting the entry of work results for the work schedule by the processor;
a second step of finding the work schedule progress by comparing the work results entered into the terminal device with the work schedule by the processor;
a third step of deciding whether reorganizing of the work schedule is needed or not by the processor, based on the degree of divergence between the work schedule and the work progress;
a fourth step of calculating the cost of the unified work group formed from the work groups for each combination of work groups by the processor when decided in the third step that reorganizing of the work schedule is needed;
a fifth step of comparing the calculated costs by the processor;
a sixth step of determining the combination of work groups for unification by the processor, based on results from the cost comparison; and
a seventh step of reorganizing the work schedule by unifying the work groups by the processor, based on the combinations that were determined.

11. The scheduling management method according to claim 10,
wherein in the sixth step, the priority of the combination of the work groups for unification is set based on results from comparing the costs; and in the seventh step, the two work groups having a maximum priority setting are unified.

12. The scheduling management method according to claim 11,
wherein in the sixth step the priority of the work groups neighboring the unified work group are refreshed.

13. The scheduling management method according to claim 10,
wherein the work schedule contains the scheduled start time and scheduled end time of the work,
wherein the work results contain the start time and end time of the work, and
wherein, in the second step, the processor finds the progress of the work by comparing the scheduled start time and scheduled end time contained in the work schedule, with the start time and end time contained in the work results.

14. The scheduling management method according to claim 10,
wherein in the sixth step, the processor unifies the work group to achieve a minimum cost.

15. The scheduling management method according to claim 10,
wherein, in the fourth step, the processor calculates the cost of the work group by summing the time required for the worker to perform work on the work target contained in the work group; the time required for the worker to move between work targets contained in the work group; and the time required for the worker to make a round-trip movement between the base and the work group.
